(19) United States
(12) Patent Application Publication
(10) Pub. No.: US 2010/0034322 A1
(43) Pub. Date: Feb. 11, 2010

(54) Method and apparatus for layer cancelling in a multiple antenna system supporting space multiplexing

(75) Inventors: Young-Seok Jung, Suwon-si (KR); Chae-Man Lim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/462,459

(22) Filed: Aug. 4, 2009

(30) Foreign Application Priority Data
Aug. 5, 2008 (KR) 10-2008-00766326

(51) Int. Cl. H04L 27/06

(52) U.S. Cl. 375/341

(57) ABSTRACT

A method and apparatus for layer canceling in a multiple antenna system supporting space multiplexing are provided. The method includes determining a Log Likelihood Ratio (LLR) for each layer of signals received through a plurality of receive antennas and ordering each layer, and performing layer canceling using the ordering result.

### PRIORITY

The present application is related to and claims priority under 35 U.S.C. §119(a) to a Korean Patent Application filed in the Korean Intellectual Property Office on Aug. 5, 2008 and assigned Serial No. 10-2008-0076326, the contents of which are herein incorporated by reference.

### TECHNICAL FIELD OF THE INVENTION

The present invention relates to a method and apparatus for layer canceling in a multiple antenna system supporting space multiplexing. More particularly, the present invention relates to a method and apparatus for ordering each channel layer on the basis of a Log Likelihood Ratio (LLR) and performing layer canceling in a Maximum Likelihood (ML) receiver.

### BACKGROUND OF THE INVENTION

A Multiple Input Multiple Output (MIMO) system is a system using a multiple antenna at each transmit/receive end. Compared to a system using a single antenna, the MIMO system can advantageously increase channel capacity in proportion to the number of antennas even without additional frequency or transmit power allocation, and thus, its active research is in progress.

The technology using the multiple antenna can be greatly divided into three schemes:

space diversity scheme of improving transmission reliability through a diversity gain corresponding to a multiple of the number of transmit/receive antennas;

space multiplexing scheme of improving a transfer rate by simultaneously transmitting a plurality of signal sequences; and

combination of the space diversity and the space multiplexing.

At present, in a 3^{rd} Generation Partnership Project Long Term Evolution (3GPP LTE) system, a multiple codeword space multiplexing scheme that is one of the space multiplexing schemes is provided. Assuming four antenna ports, the multiple codeword space multiplexing scheme can transmit two different codewords to each antenna. The two different codewords can be encoded in a different scheme and have a different modulation sequence.

In a 2×2 MIMO system, a Modified Maximum Likelihood (MML) receiver of low complexity is proposed. The MML receiver can obtain the same performance as a Maximum Likelihood (ML) receiver using a maximum log map. Also, as illustrated in FIG. 1, a Minimum Mean Square Error-Successive Interference Cancellation (MMSE-SIC) receiver is proposed. The MMSE-SIC receiver performs layer canceling by first decoding a layer having a strong receive signal through layer ordering, regenerating the signal, and subtracting the regenerated signal from the original receive signal.

In FIG. 1, when a receive antenna is of ‘M’ number, the MMSE-SIC receiver includes decoders of ‘M’ number or less, and receives a data stream from a transmitter through the receive antenna of ‘M’ number. The MMSE-SIC receiver can determine a Signal-to-Noise Ratio (SNR) or capacity in one code block unit by stream and perform layer ordering by stream. That is, the MMSE-SIC receiver first decodes starting from a stream determined to pass through the best channel, feeds back the stream, subtracts the fed-back stream from a receive signal, and decodes the next streams in ordered sequence and, until finishing decoding all streams, repeatedly performs such an operation. The MMSE-SIC receiver distinguishes filter output streams as a layer having good performance or a layer having bad performance on the basis of Representative Layer Ordering (RLO).

In general, as illustrated in FIG. 2, the performances of the MMSE-SIC and ML receivers are inversely related to one another depending on the coding rate. That is, when the coding rate is decreased by ⅓, as illustrated in FIG. 2A, the MMSE-SIC receiver can obtain a higher performance than the ML receiver. Inversely, when the coding rate is raised by ¾, as illustrated in FIG. 2B, the ML receiver can obtain a higher performance than the MMSE-SIC receiver. This is because the performance of first layer coding by the MMSE-SIC decreases at a high coding rate, and thus, layer interference cancelation is erroneously performed. Because the first layer coding performance increases at a low coding rate, the layer interference cancelation effect increases.

As described above, because the performances of conventional MMSE-SIC and ML schemes are inversely related to one another depending on the coding rate, there is a problem that performance loss is generated in any scheme.

### SUMMARY OF THE INVENTION

To address the above-discussed deficiencies of the prior art, it is a primary aspect of the present invention to substantially solve at least the above problems and/or disadvantages and to provide at least the advantages below. Accordingly, one aspect of the present invention is to provide a method and apparatus for performing layer canceling and improving system performance in a Maximum Likelihood (ML) receiver of a multiple antenna system supporting space multiplexing.

Another aspect of the present invention is to provide a method and apparatus for ordering each layer on the basis of a Log Likelihood Ratio (LLR) and performing layer canceling in an ML receiver of a multiple antenna system.

The above aspects are achieved by providing a method and apparatus for layer canceling in a multiple antenna system supporting space multiplexing.

According to one aspect of the present invention, a method for layer canceling in a multiple antenna system supporting space multiplexing is provided. The method includes determining a Log Likelihood Ratio (LLR) for each layer of signals received through a plurality of receive antennas and ordering each layer, and performing layer canceling using the ordering result.

According to another aspect of the present invention, an apparatus for layer canceling in a multiple antenna system supporting space multiplexing is provided. The apparatus includes a layer ordering unit and a layer canceller. The layer ordering unit determines an LLR for each layer of signals received through a plurality of receive antennas, and orders each layer. The layer canceller performs layer canceling using the ordering result.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without, limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of a Minimum Mean Square Error-Successive Interference Cancellation (MMSE-SIC) receiver according to the conventional art;

FIGS. 2A and 2B are graphs illustrating performance of an MMSE-SIC receiver and a Maximum Likelihood (ML) receiver according to the conventional art;

FIG. 3 is a block diagram illustrating a construction of an apparatus for layer canceling in an ML receiver according to the present invention;

FIG. 4 is a block diagram illustrating a detailed construction of an ML demodulator in an ML receiver according to the present invention;

FIG. 5 is a flow diagram illustrating a procedure of generating an ordering sequence of each layer in an ML receiver according to an exemplary embodiment of the present invention;

FIGS. 6 to 8 are graphs illustrating receiver performance according to the conventional art and an exemplary embodiment of the present invention; and

FIGS. 9 and 10 are graphs illustrating receiver performance by a layer canceling execution unit according to an exemplary embodiment of the present invention.

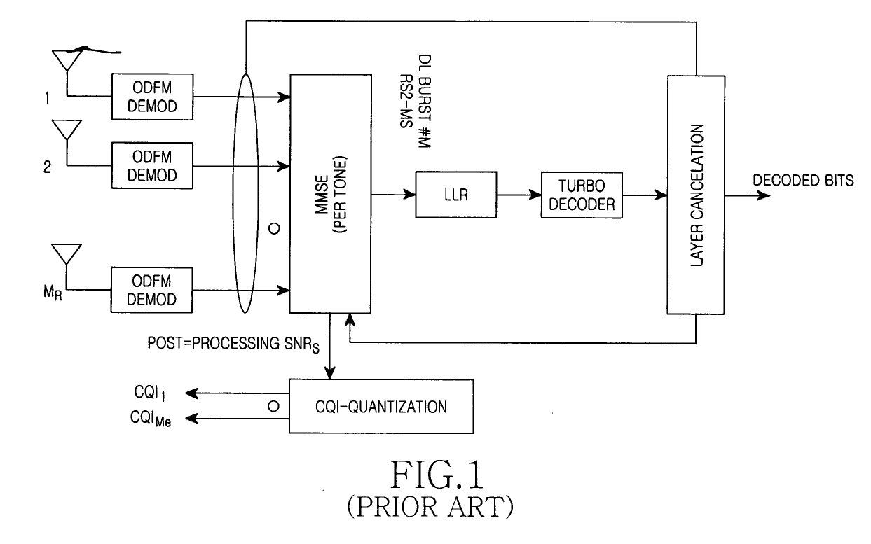

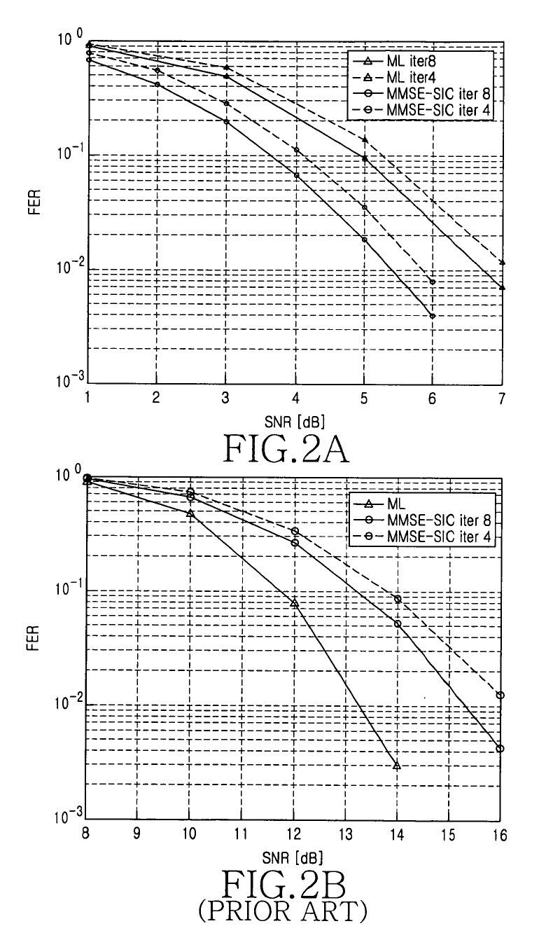

### DETAILED DESCRIPTION OF THE INVENTION

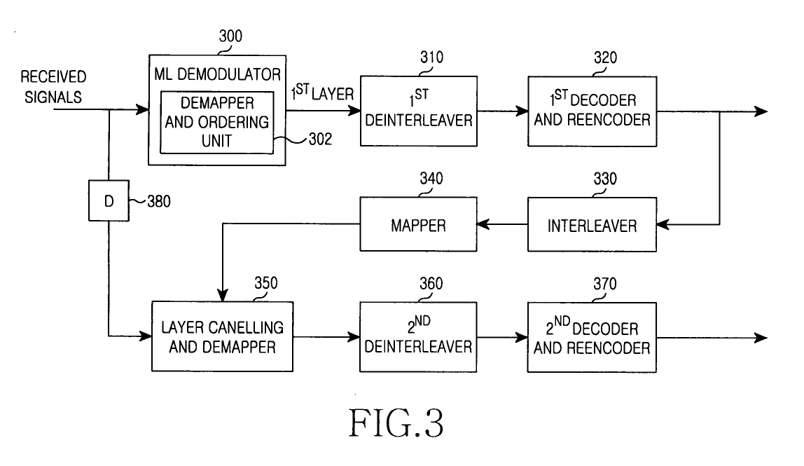

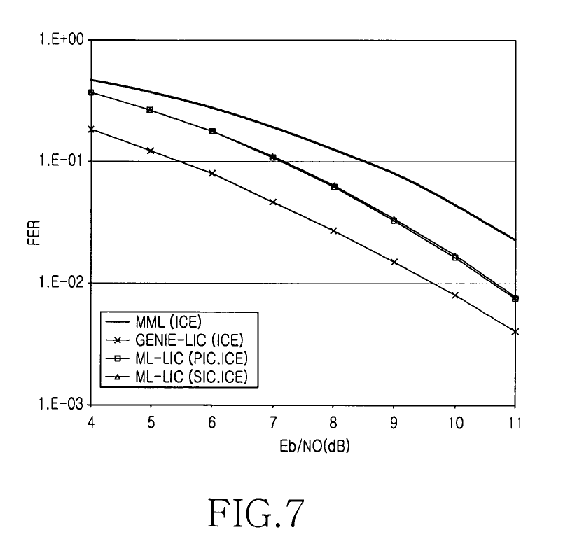

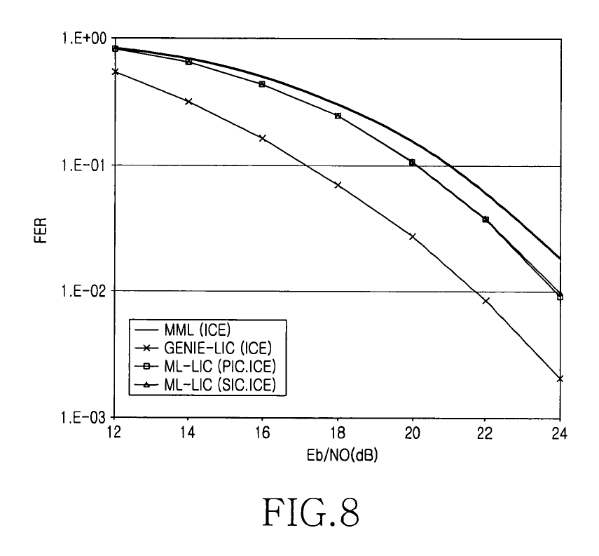

FIGS. 3 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The following description is made for a method and apparatus for ordering each layer on the basis of a Log Likelihood Ratio (LLR) and performing layer canceling in a Maximum Likelihood (ML) receiver supporting a multiple antenna system. For example, the present invention describes an ML receiver in a 2×2 Multiple Input Multiple Output (MIMO) system, and is also identically applicable to a Modified Maximum Likelihood (MML) receiver.

FIG. 3 is a block diagram illustrating a construction of an apparatus for layer canceling in an ML receiver according to the present invention.

Referring to FIG. 3, the ML receiver includes an ML demodulator 300, a first deinterleaver 310, a first decoder and reencoder 320, an interleaver 330, a mapper 340, a layer cancelling and demapper 350, a second deinterleaver 360, a second decoder and reencoder 370, and a delay 380.

The ML demodulator 300 determines an LLR value of each layer from signals received through a plurality of receive antennas. Particularly, the ML demodulator 300 includes a demapper and layer ordering unit 302 and, thus, performs symbol demapping for the signals received through the plurality of receive antennas, determines an LLR for each layer, and performs layer ordering.

That is, according to the present invention, the ML demodulator 300 determines an LLR by layer as expressed in Equation 1 below, accumulates the determined LLR by layer during a predetermined interval, and determines an average LLR value by layer. The ML demodulator 300 compares the determined average LLR value by layer and selects a layer having a high-reliable average LLR to first decode the layer. If each layer has a different modulation sequence, the ML demodulator 300 determines a weight for each layer, multiplies the determined average LLR value by the weight, compares the average LLR value of each layer, and performs layer ordering.

Equation 1 below shows a method of comparing an LLR of each layer for layer ordering:

$$( ( LLR {1}_{AVG} = {\sum }_{i = 1}^{N} \vert LLR 1 \vert ) > W \cdot ( LLR {2}_{AVG} = {\sum }_{i = 1}^{N} \vert LLR 2 \vert ) ) . \qquad [ Eqn . 1 ]$$

In Equation 1, the ‘LLR1’ represents an LLR for a layer 1, the ‘LLR2’ represents an LLR for a layer 2, and the ‘LLR1_{AVG}’ and ‘LLR2_{AVG}’ represent average LLRs for the layer 1 and layer 2 during a predetermined interval. The ‘W’ represents a weight based on a modulation sequence, and the ‘N’ represents the number of accumulation times of the LLR.

That is, as expressed in Equation 1, the ML demodulator 300 determines an average LLR value of each layer for a predetermined interval, compares its size, selects a layer having a high average LLR value as a first demodulation layer, and selects a layer having a low average LLR value as a second demodulation layer.

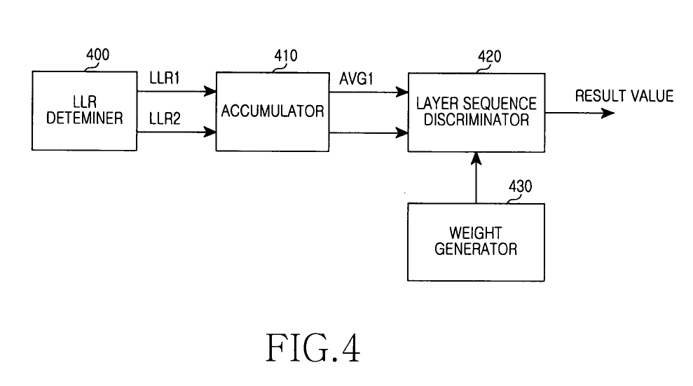

According to the present invention, as illustrated in FIG. 4, the ML demodulator 300 includes an LLR determiner 400, an accumulator 410, a layer sequence discriminator 420, and a weight generator 430 and, thus, determines an LLR of each layer as expressed in Equation 1 and performs layer ordering.

The ML demodulator 300 is described in detail with reference to FIG. 4. The LLR determiner 400 determines an LLR by layer. The accumulator 410 accumulates the LLR by layer determined in the LLR determiner 400 during a predetermined interval, determines an average LLR value during the predetermined interval, and provides the determined average LLR value to the layer sequence discriminator 420.

If each layer has a different modulation sequence, the weight generator 430 determines a weight for each layer and provides the determined weight to the layer sequence discriminator 420.

The layer sequence discriminator 420 multiplies a layer having any one of the average LLR values determined on a per-layer basis by the weight, acquires an LLR value based on a modulation sequence, compares LLR values of two layers, selects a layer having a high average LLR value as a first demodulation layer, and selects a layer having a low average LLR value as a second demodulation layer.

When the ML demodulator 300 performs layer ordering using an LLR value, if using an LLR value for a current transport lock, the ML demodulator 300 may cause a time delay in demodulation and, thus, will be able to perform layer ordering using an LLR value for a previous transport block.

The first deinterleaver 310 receives a signal of a first layer from the ML demodulator 300 and performs deinterleaving corresponding to interleaving performed in a transmitter. The first decoder and reencoder 320 decodes the signal deinterleaved in the first deinterleaver 310 according to a predefined decoding scheme.

To regenerate the signal of the first layer, the interleaver 330 interleaves a signal decoded in the first decoder and reencoder 320 pursuant to a predetermined rule and outputs the interleaved signal to the mapper 340. The mapper 340 performs bit/symbol mapping to the interleaved signal and provides the signal to the layer cancelling and demapper 350.

The layer cancelling and demapper 350 performs layer canceling for canceling a signal from the mapper 340 (i.e., a regenerated signal of a first layer) from the original receive signal. The layer cancelling and demapper 350 can perform the layer canceling in a code block unit or a transport block unit. At this time, only if a result of a Cyclic Redundancy Check (CRC) for a code block of the first layer or a transport block is good, the layer cancelling and demapper 350 performs layer canceling for a corresponding code block or transport block.

The second deinterleaver 360 deinterleaves a signal received from the layer cancelling and demapper 350, and outputs the deinterleaved signal to the second decoder and reencoder 370. The second decoder and reencoder 370 decodes the signal interleaved in the second deinterleaver 360 according to a predefined decoding scheme.

The delay 380 delays signals received through the plurality of receive antennas by a predetermined time, and provides the delayed signals to the layer cancelling and demapper 350. That is, the delay 380 delays the received signals until the signal of the first layer is decoded, regenerated, and input to the layer cancelling and demapper 350.

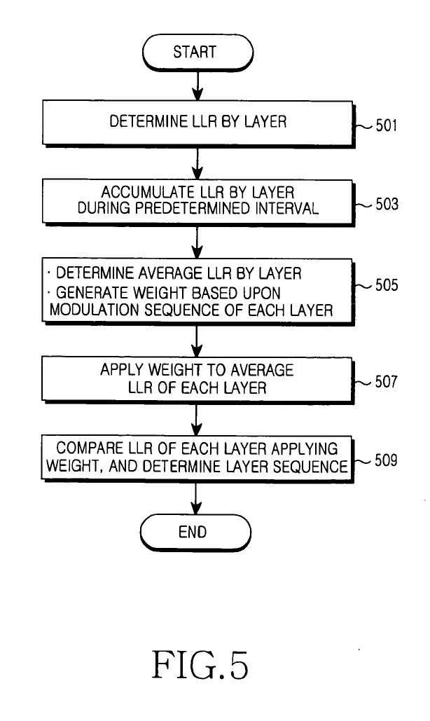

FIG. 5 is a flow diagram illustrating a procedure of generating an ordering sequence of each layer in an ML receiver according to an exemplary embodiment of the present invention.

Referring to FIG. 5, in step 501, the ML receiver determines an LLR by layer and, in step 503, accumulates the determined LLR by layer during a predetermined interval.

Then, in step 505, the ML receiver determines an average LLR value during the predetermined interval and, if each layer has a different modulation sequence, determines a weight for each layer.

Then, in step 507, the ML receiver multiplies a layer having any one of the average LLR values determined on a per-layer basis by the weight, and acquires an LLR value based on a modulation sequence. In step 509, the ML receiver compares LLR values of two layers, selects a layer having a high average LLR value as a first demodulation layer, and selects a layer having a low average LLR value as a second demodulation layer.

Then, the ML receiver terminates the procedure according to the present invention.

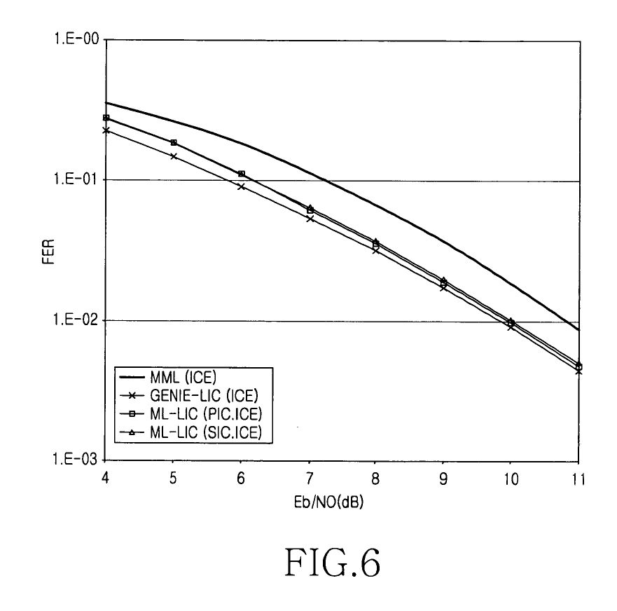

FIGS. 6 to 8 are graphs illustrating receiver performance according to the conventional art and an exemplary embodiment of the present invention. FIGS. 6 to 8 illustrate coding rate dependent performance of a receiver (ML-LIC or Genie-LIC) of the conventional art and an ML receiver (ML-LIC) of the present invention. Here, the Genie-LIC means a receiver assuming perfect decoding of a first layer.

Referring to FIGS. 6 to 8, it can be appreciated that the ML receiver (ML-LIC) of the present invention has a higher performance compared to an MML receiver of the conventional art irrespective of the coding rate. It can be appreciated that, as the coding rate decreases, the ML-LIC of the present invention approaches performance of the Genie-LIC.

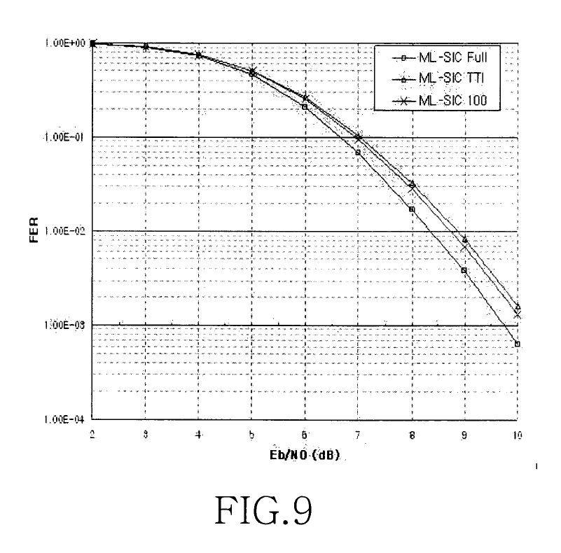

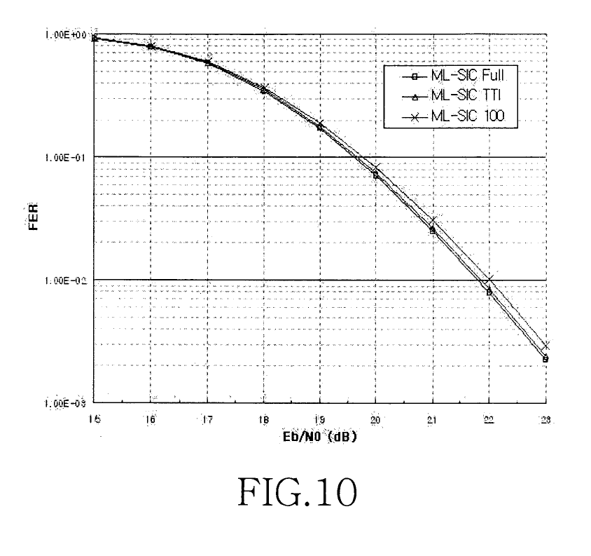

FIGS. 9 and 10 are graphs illustrating receiver performance by layer canceling execution unit according to an exemplary embodiment of the present invention.

FIGS. 9 and 10 illustrate performance for a case (ML-SIC Full) where an LLR for a current transport block is applied to the current transport block, a case (ML-SIC TTI) where an LLR for a previous transport block is applied to a current transport block, and a case (ML-SIC 100) where an LLR for one hundred symbols of a current transport block is applied to the current transport block. In FIGS. 9 and 10, it can be appreciated that the case (ML-SIC TTI) and the case (ML-SIC 100) show a slightly higher performance than the case (ML-SIC Full).

That is, if using an LLR value for the whole current transport block, it may cause a time delay in demodulation. Thus, it is desirable to perform layer ordering using an LLR value for a previous transport block or using an LLR value for a predetermined number of symbols existing in front in a current transport block.

The present invention is able to obtain the optimum reception performance in a multiple codeword space multiplexing mode irrespective of the coding rate by ordering each layer on the basis of an LLR and performing layer canceling in an ML receiver of a multiple antenna system supporting space multiplexing. Also, the present invention can obtain a considerable gain in a transfer rate and a bit rate.

Although the present disclosure has been described with an exemplary embodiment, various changes and modifications may be suggested to one skilled in the art. It is intended that the present disclosure encompass such changes and modifications as fall within the scope of the appended claims

What is claimed is:

1. A method for layer canceling in a multiple antenna system supporting space multiplexing, the method comprising:
determining a Log Likelihood Ratio (LLR) for each layer of signals received through a plurality of receive antennas, and ordering each layer; and
performing layer canceling using the ordering result.

2. The method of claim 1, wherein ordering each layer comprises:
determining an average Log Likelihood Ratio of each layer for a predetermined interval; and
ordering each layer according to the average Log Likelihood Ratio.

3. The method of claim 2, further comprising: if each layer has a different modulation sequence,
applying a weight to the determined average Log Likelihood Ratio of each layer; and
ordering each layer according to the weighted average Log Likelihood Ratio.

4. The method of claim 1, wherein determining the Log Likelihood Ratio for each layer and ordering each layer comprises using any one of a Log Likelihood Ratio value for a current transport block, a Log Likelihood Ratio value for a previous transport block, and a Log Likelihood Ratio value for a predetermined number of symbols in the previous transport block.

5. The method of claim 1, wherein performing the layer canceling using the ordering result comprises:
performing decoding for a layer ordered as a first layer according to the ordering result;
regenerating a signal of the first layer; and
canceling the regenerated signal of the first layer from the signals received through the plurality of receive antennas.

6. The method of claim 5, further comprising delaying the signals received through the plurality of receive antennas according to a predetermined time until the signal of the first layer is generated.

7. An apparatus for layer canceling in a multiple antenna system supporting space multiplexing, the apparatus comprising:
a layer ordering unit for determining a Log Likelihood Ratio (LLR) for each layer of signals received through a plurality of receive antennas, and ordering each layer; and
a layer canceller for performing layer canceling using the ordering result.

8. The apparatus of claim 7, wherein the layer ordering unit comprises:
an LLR average determiner for determining an average Log Likelihood Ratio of each layer for a predetermined interval; and
ordering each layer according to the average Log Likelihood Ratio.

9. The apparatus of claim 8, further comprising a weight determiner for determining a weight for each layer having a different modulation sequence,
wherein the layer sequence discriminator applies the weight to the average Log Likelihood Ratio of each layer, and orders each layer according to the weighted average Log Likelihood Ratio.

10. The apparatus of claim 7, wherein determining the Log Likelihood Ratio of each layer and ordering each layer comprises using any one of an LLR value for a current transport block, an LLR value for a previous transport block, and an LLR value for a predetermined number of symbols in the previous transport block.

11. The apparatus of claim 7, further comprising a decoder and reencoder for performing decoding for a layer ordered as a first layer according to the ordering result, and regenerating a signal of the first layer,
wherein the layer canceller cancels the regenerated signal of the first layer from the signals received through the plurality of receive antennas.

12. The apparatus of claim 11, further comprising a delay for, until the signal of the first layer is regenerated, delaying the signals received through the plurality of receive antennas for a predetermined time, and providing the signals to the layer canceller.

13. An apparatus for layer canceling in a multiple antenna system supporting space multiplexing, the apparatus configured to:
determine an average Log Likelihood Ratio for each layer of signals received through a plurality of receive antennas for a predetermined interval;
order each layer according to the average Log Likelihood Ratio; and
perform layer canceling using the ordering result.

14. The apparatus of claim 13, wherein if each layer has a different modulation sequence, the apparatus is further configured to:
apply a weight to the determined average Log Likelihood Ratio of each layer, the weight being based upon the modulation sequence corresponding to each layer; and
ordering each layer according to the weighted average Log Likelihood Ratio.

15. The apparatus of claim 13, wherein in performing layer canceling using the ordering result, the apparatus is further configured to:
perform decoding for a layer ordered as a first layer according to the ordering result;
regenerate a signal of the first layer; and
cancel the regenerated signal of the first layer from the signals received through the plurality of receive antennas.

16. The apparatus of claim 15, wherein the apparatus is further configured to delay the signals received through the plurality of receive antennas according to a predetermined time until the signal of the first layer is generated.

17. A method for layer canceling in a multiple antenna system supporting space multiplexing, the method comprising:
determining an average Log Likelihood Ratio for each layer of signals received through a plurality of receive antennas for a predetermined interval
ordering each layer according to the average Log Likelihood Ratio; and
performing layer canceling using the ordering result.

18. The method of claim 17, further comprising: if each layer has a different modulation sequence,
applying a weight to the determined average Log Likelihood Ratio of each layer, the weight being based upon the modulation sequence corresponding to each layer; and
ordering each layer according to the weighted average Log Likelihood Ratio.

19. The method of claim 17, wherein performing the layer canceling using the ordering result comprises:
performing decoding for a layer ordered as a first layer according to the ordering result;
regenerating a signal of the first layer; and
canceling the regenerated signal of the first layer from the signals received through the plurality of receive antennas.

20. The method of claim 19, further comprising delaying the signals received through the plurality of receive antennas according to a predetermined time until the signal of the first layer is generated.
